(19) United States
(12) Patent Application Publication
(10) Pub. No.: US 2013/0106772 A1
(43) Pub. Date: May 2, 2013

(54) DIFFERENTIATING INPUTS OF A DISPLAY DEVICE

(71) Applicant: Seungil Kim, Seoul (KR)

(72) Inventor: Seungil Kim, Seoul (KR)

(73) Assignee: EMPIRE TECHNOLOGY DEVELOPMENT LLC, Wilmington, DE (US)

(21) Appl. No.: 13/520,521

(22) PCT Filed: Sep. 28, 2011
(86) PCT No.: PCT/US11/53733

§ 371 Date: Jul. 3, 2012

(51) Int. Cl. G06F 3/01; G06F 3/044; G06F 3/033; G06F 3/041

(52) U.S. Cl. CPC G06F 3/01; G06F 3/041; G06F 3/044; G06F 3/033
USPC 345/174; 345/156; 345/173; 345/179

(57) ABSTRACT

Implementations and techniques for differentiating inputs of a display device are generally disclosed.

### BACKGROUND

Unless otherwise indicated herein, the approaches described in this section are not prior art to the claims in this application and are not admitted to be prior art by inclusion in this section.

Touch screens are electronic visual displays that can detect the presence and location of a touch within a display area. Touch screens may typically be unconditionally responsive to conducting objects bigger than a certain size of contact area. Thus, different users and/or different touch input objects may not be able to be identified by such touch screens.

### SUMMARY

Some example methods, apparatus, and systems described herein may relate to differentiating inputs of a display device.

Some example methods, apparatus, and systems related to differentiating inputs of a display device may be implemented in a display device. Such an apparatus may include the display device, an input sensitive screen, conductive material, a processor, and a signal bearing medium. The input sensitive screen may be included in the display device. The conductive material may be included in the display device. The conductive material may provide an electric field for the input sensitive screen. The processor may be coupled to the display device. The signal bearing medium may comprise machine-readable instructions stored thereon, which, if executed by the processor, may operatively enable a computing device to receive an indication of a first distortion of the electric field of the display device, where the first distortion may have a first pattern. The first pattern may be associated with a first input. An indication of a second distortion of the electric field of the display device may be received, where the second distortion may have a second pattern. A determination may be made if the first pattern and the second pattern are substantially similar. The second pattern may be associated with the first input if it is determined that the first pattern and the second pattern are substantially similar. The second pattern may be associated with a second input if it is determined that the first pattern and the second pattern are not substantially similar.

Some example methods, apparatus, and systems related to differentiating inputs of a display device may be implemented in a display device. Such methods may include receiving an indication of a first distortion of an electric field of the display device, where the first distortion may have a first pattern. The first pattern may be associated with a first input. An indication of a second distortion of the electric field of the display device may be received, where the second distortion may have a second pattern. A determination may be made if the first pattern and the second pattern are substantially similar. The second pattern may be associated with the first input if it is determined that the first pattern and the second pattern are substantially similar. The second pattern may be associated with a second input if it is determined that the first pattern and the second pattern are not substantially similar.

Some example methods, apparatus, and systems related to differentiating inputs of a display device may be implemented in a display device. Such an article may include a signal bearing medium comprising machine-readable instructions stored thereon, which, if executed by one or more processors, operatively enable a computing device to receive an indication of a first distortion of an electric field of the display device, where the first distortion may have a first pattern. The first pattern may be associated with a first input. An indication of a second distortion of the electric field of the display device may be received, where the second distortion may have a second pattern. A determination may be made if the first pattern and the second pattern are substantially similar. The second pattern may be associated with the first input if it is determined that the first pattern and the second pattern are substantially similar. The second pattern may be associated with a second input if it is determined that the first pattern and the second pattern are not substantially similar.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates an example diagram of a display device that is arranged in accordance with at least some embodiments of the present disclosure;

FIG. 2 illustrates an example diagram of input devices that is arranged in accordance with at least some embodiments of the present disclosure;

FIG. 3 illustrates another example diagram of input devices that is arranged in accordance with at least some embodiments of the present disclosure;

FIG. 4 illustrates a further example diagram of input devices that is arranged in accordance with at least some embodiments of the present disclosure;

FIG. 5 illustrates an example diagram of an input device interacting with a sensor grid that is arranged in accordance with at least some embodiments of the present disclosure;

FIG. 6 illustrates an example diagram of input devices interacting with a display device that is arranged in accordance with at least some embodiments of the present disclosure;

FIG. 7 illustrates another example diagram of input devices interacting with a display device that is arranged in accordance with at least some embodiments of the present disclosure;

FIG. 8 illustrates an example process for differentiating inputs of a display device that is arranged in accordance with at least some embodiments of the present disclosure;

FIG. 9 is an illustration of an example computer program product that is arranged in accordance with at least some embodiments of the present disclosure; and

FIG. 10 is a block diagram of an illustrative embodiment of a computing device arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to differentiating inputs of a display device.

As will be discussed in greater detail below, touch screen-type display devices may be configured to differentiate between multiple inputs. For example, two or more input devices (e.g., a stylus) may be utilized with distinct conductive patterns. In such an example, a display device may be configured to differentiate between an input device with a first conductive pattern and an input device with a second conductive pattern.

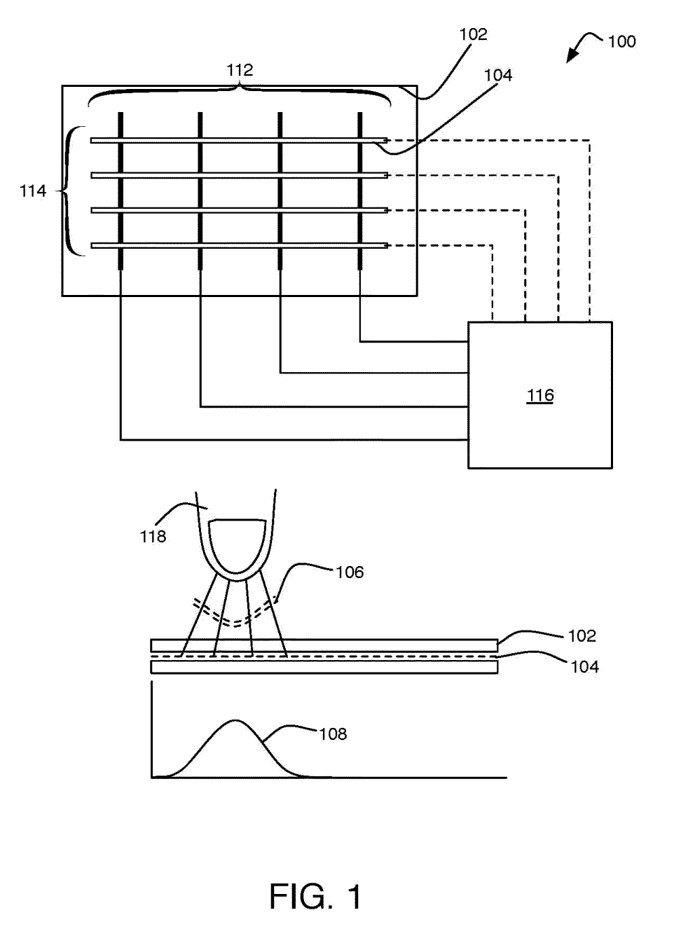

FIG. 1 illustrates an example diagram of a display device 100 that is arranged in accordance with at least some embodiments of the present disclosure. In the illustrated example, display device 100 may be a touch screen type display device, such as a projected capacitive touch technology type display device, for example.

In some examples, display device 100 may include an input sensitive screen 102 and/or a conductive material 104. Input sensitive screen 102 may be included in display device 100 and may be capable of transferring a capacitive touch 106 to conductive material 104.

Conductive material 104 may be included in display device 100. Conductive material 100 may provide an electric field for input sensitive screen 102. For example, such an electric field may have a distortion 108 in response to a transfer of capacitive touch 106 to conductive material 104 through input sensitive screen 102.

In some examples, conductive material 104 may be oriented and arranged as a sensor grid. In such an example, conductive material 104 may include sensors 112 oriented to be capable of detecting vertical touch input and/or sensors 114 oriented to be capable of detecting horizontal touch input.

In some examples, display 100 may include a control unit 116. For example, control unit 116 may include a processor and a signal bearing medium. The processor may be coupled to display device 100. The signal bearing medium may comprise machine-readable instructions stored thereon, which, if executed by the processor, may operatively enable display device 100 to differentiate inputs of display device 100.

In operation, display 100 may capture information about touch by measuring a change in capacitance when a finger 118 or other conducting object comes in contact with display 100. As will be discussed in greater detail below, the machine-readable instructions may operatively enable display device 100 to differentiate inputs of display device 100. For example, display device 100 may receive an indication of a first distortion of the electric field of display device 100, where the first distortion may have a first pattern. The first pattern may be associated with a first input. Next, an indication of a second distortion of the electric field of display device 100 may be received, where the second distortion may have a second pattern. A determination may be made if the first pattern and the second pattern are substantially similar. For example, such pattern recognition may utilize one or more pattern recognition algorithms, such as regression algorithms, supervised classification algorithms, unsupervised clustering algorithms, the like, and/or combinations thereof. In cases where it is determined that the first pattern and the second pattern are substantially similar, the second pattern may be associated with the first input. In cases where it is determined that the first pattern and the second pattern are not substantially similar, the second pattern may be associated with a second input. For example, the first input may include an input associated with a first user and/or a first input device. Similarly, the second input may include an input associated with a second user and/or a second input device.

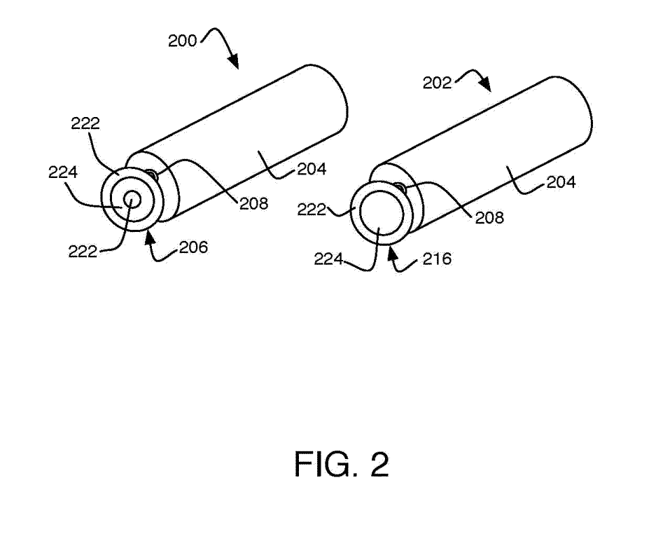

FIG. 2 illustrates another example diagram of input devices that is arranged in accordance with at least some embodiments of the present disclosure. In the illustrated example, a first and a second input device 200 and 202 are shown as stylus-type input devices. In such an example, first input device 200 may include a pen shaft 204 operatively associated with a conductive tip 206.

In some examples, pen shaft 204 may be rotatably coupled to conductive tip 206 via a rotatable coupling 208. In such an example, the whole touch surface of conductive tip 206 may be contacted with input sensitive screen 102 (see, e.g., FIG. 1). As a user changes the orientation of pen shaft 204 with respect to input sensitive screen 102 (see, e.g., FIG. 1), rotatable coupling 208 may permit the whole touch surface of conductive tip 206 to remain contacted.

Second input device 202 may have the same and/or similar structure to that of first input device 200. Second input device 202 may include pen shaft 204 operatively associated with a second conductive tip 216. For example, pen shaft 204 may be rotatably coupled to second conductive tip 216 via rotatable coupling 208.

In the illustrated example, conductive tip 206 and second conductive tip 216 may individually provide distortions to the electric field of display device 100 (see, e.g., FIG. 1). However, these distortions may differ from one another depending on the particular properties of conductive tip 206 and second conductive tip 216. For example, conductive tip 206 may include a capacitive pattern. In the illustrated example, such a capacitive pattern of conductive tip 206 may be formed from first capacitance areas 222 and second capacitance areas 224. For example, first capacitance areas 222 may be formed from a first conductive material having a first capacitance and second capacitance areas 224 may be formed from a second conductive material having a second capacitance distinct from the first capacitance.

Similarly, capacitive pattern of second conductive tip 216 may be formed from first capacitance areas 222 and second capacitance areas 224, where the capacitive patterns of second conductive tip 216 and conductive tip 206 are distinct from one another. It will be appreciated that other capacitive areas may be used in addition to first capacitance areas 222 and second capacitance areas 224. It will be also be appreciated that capacitive pattern of second conductive tip 216 need not be formed with the same materials or capacitance values as those used for conductive tip 206, and may instead be formed with materials distinct from conductive tip 206.

In some examples, first input device 200 (and/or second input device 202) may be a stylus-type input device configured to provide one or more conductive patterns. For example, a stylus-type input device may have a conductive tip as previously described with respect to FIG. 2 configured to provide both conductive tip 206 and second conductive tip 216 based at least in part on a selector type mechanism on the stylus-type input device. A selector type mechanism may include a variety of selector type mechanism such as, but not limited to, a clicking end, where a first push of the clicking end may cause the stylus-type input device to have a conductive tip such as the conductive tip 206 previously described with respect to FIG. 2. A second push of the clicking end may cause the stylus-type input device to have a conductive tip such as the conductive tip 216 previously described with respect to FIG. 2. A wide variety of selector type mechanism may be utilized such as, but not limited to, a button on the side of the stylus-type input device facilitating one or more types of conductive tips, and accordingly, the claimed subject matter is not to be limited with this respect. In one example, such a selector type mechanism may operate in a mechanical manner to retract conductive tip 206 and then extend second conductive tip 216 with respect to the stylus-type input device. In such an example, a structure similar to that used in multi-color pens having multiple ink tubes might be utilized for retracting conductive tip 206 and then extending second conductive tip 216.

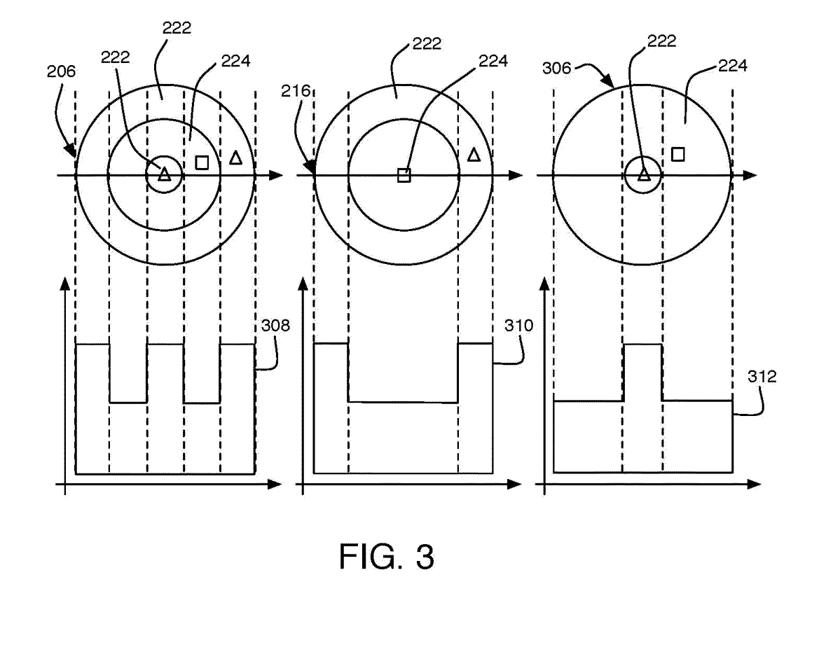

FIG. 3 illustrates another example diagram of input devices that is arranged in accordance with at least some embodiments of the present disclosure. In the illustrated example, a third conductive tip 306 may be formed from first capacitance areas 222 and second capacitance areas 224, where the capacitive patterns of third conductive tip 306, second conductive tip 216, and conductive tip 206 are distinct from one another. It will be appreciated that other capacitive areas may be used in addition to first capacitance areas 222 and second capacitance areas 224. It will be also be appreciated that capacitive pattern of third conductive tip 306 need not be formed with the same materials or capacitance values as those used for conductive tip 206, and may instead be formed with materials distinct from conductive tip 206.

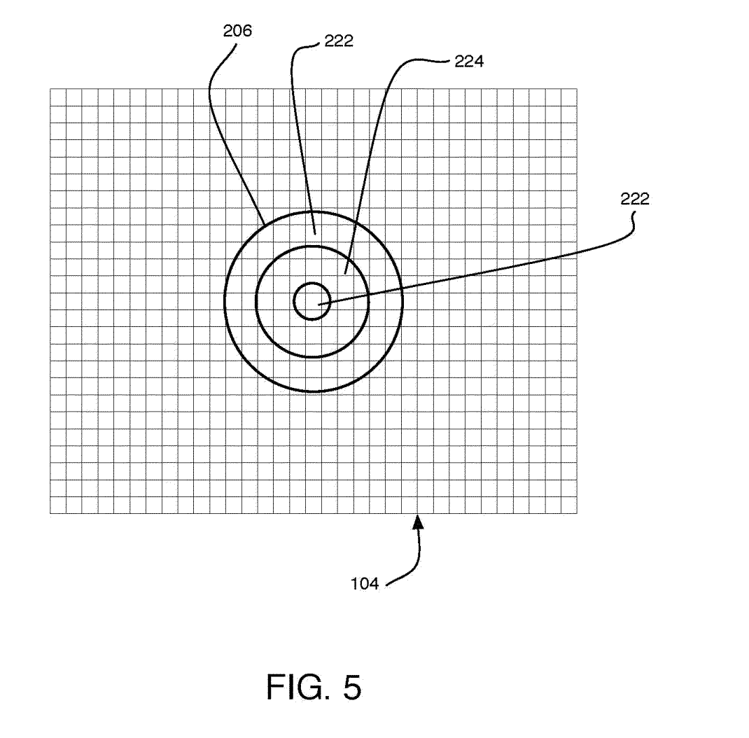

In the illustrated example, capacitance areas 222 may create more capacitance than second capacitance areas 224. As shown, conductive tip 206 may have a capacitive pattern 308, second conductive tip 216 may have a second capacitive pattern 310, and third conductive tip 306 may have a third capacitive pattern 312. Capacitive pattern 308, second capacitive pattern 310, and third capacitive pattern 312 may be distinct from one another and may individually provide distortions to the electric field that may be differentiated by display device 100 (see, e.g., FIG. 1). For example, a first distortion associated with capacitive pattern 308 (e.g., caused by variations in conductive material) and a second distortion associated with second capacitive pattern 310 (e.g., caused by variations in conductive material) may be differentiated by display device 100 (see, e.g., FIG. 1). Additional details regarding capacitive patterns being differentiated by display device 100 (see, e.g., FIG. 1) will be discussed below with regard to FIG. 5.

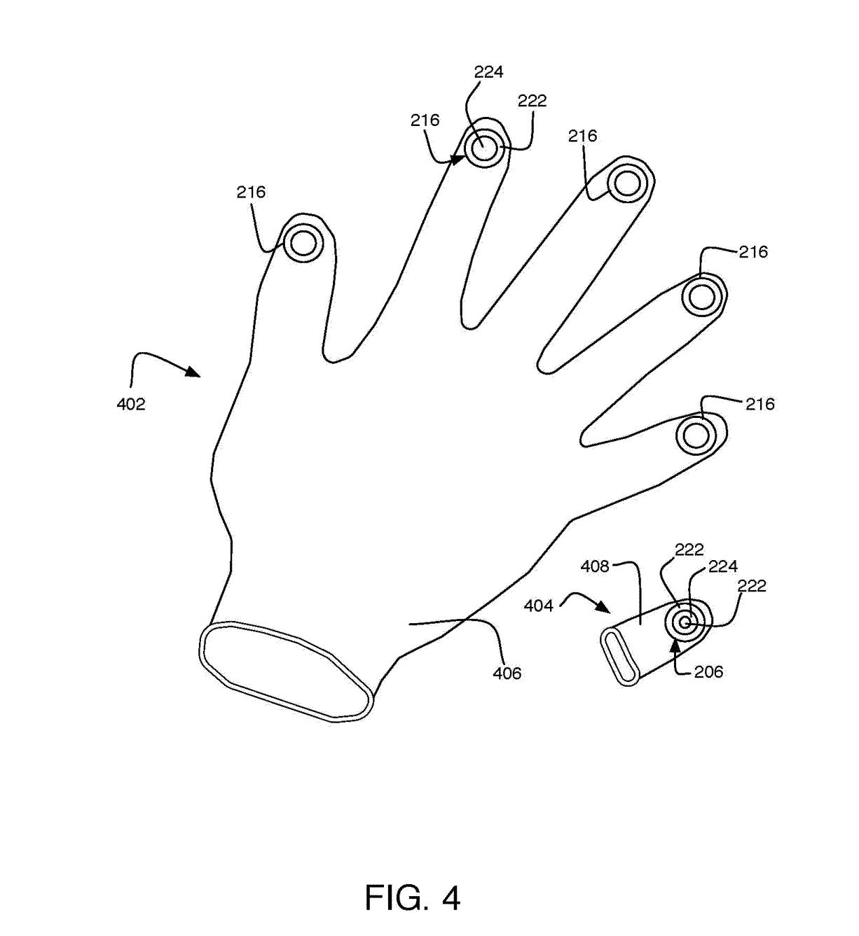

FIG. 4 illustrates a further example diagram of input devices that is arranged in accordance with at least some embodiments of the present disclosure. In the illustrated example, a first and a second input device 402 and 404 are shown as including a hand glove 406 and/or a finger cover 408, respectively. In such an example, first input device 402 may include hand glove 406 being operatively associated with one or more conductive tips 216. As shown, hand glove 406 may have five conductive tips 216 of the same conductive pattern, each associated with an individual digit. Alternatively, hand glove 406 may have conductive tips of differing conductive patterns (e.g., differing conductive patterns associated with each digit). Additionally or alternatively, hand glove 406 may have less than five digits associated with conductive tips (e.g., conductive tip 216 associated just the thumb and index finger digits, or just index finger digit, for example). Similarly, second input device 404 may include finger cover 408 being operatively associated with conductive tip 206.

In operation, various touch objects such as hand glove 406 or finger cover 408 can be distinguished by the associated conductive patterns. Thus, hand glove 406 (and/or individual digits of hand glove 406) or finger cover 408 may be differentiated by display device 100 (see, e.g., FIG. 1).

For example, display device 100 may apply a first user interface when being touched by a user's left hand glove 406 (or by individual hand glove 406 digits or finger cover 408) and a second user interface when being touched by a user's right hand glove 406 (or by individual hand glove 406 digits or finger cover 408).

FIG. 5 illustrates an example diagram of an input device interacting with a sensor grid 500 that is arranged in accordance with at least some embodiments of the present disclosure. In the illustrated example, conductive material 104 may be oriented and arranged as a sensor grid 500. Sensor grid 500 may be associated with one or more conductive tips 206 when one or more input devices 200 (see, e.g., FIG. 2) are in contact with input sensitive screen 102 (see, e.g., FIG. 1).

Capacitance areas 222 may create more amount of capacitance than second capacitance areas 224 when associated with sensor grid 500. For example, capacitance areas 222 may create 3.0 capacitance output for sensor grid 500, while second capacitance areas 224 may create a 1.5 capacitance output for sensor grid 500. The remaining areas of conductive material 104 may have a zero or near zero capacitance. In operation, a first distortion associated with conductive tip 206 and a second distortion associated with second conductive tip 216 (see, e.g., FIG. 2) may be differentiated by display device 100 (see, e.g., FIG. 1).

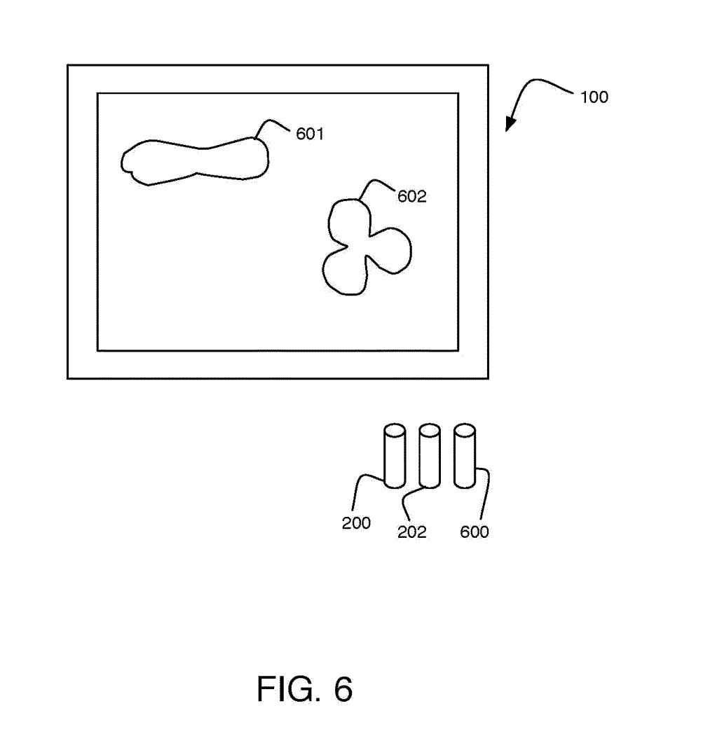

FIG. 6 illustrates an example diagram of input devices interacting with display device 100 that is arranged in accordance with at least some embodiments of the present disclosure. In the illustrated example, one or more users may interact with display device 100 via two or more input devices (e.g., first input device 200, second input device 202, and/or third input device 600). First input device 200, second input device 202, and/or third input device 600 may be stylus-type input devices (see, e.g., FIG. 2), hand glove-type input devices (see, e.g., FIG. 4), finger cover-type input devices (see, e.g., FIG. 4), the like, and/or combinations thereof.

First input device 200, second input device 202, and/or third input device 600 may each have capacitive patterns that may be distinct from one another and may individually provide distortions to the electric field that may be differentiated by display device 100. For example, a first distortion associated with first input device 200 and a second distortion associated with second input device 202 may be differentiated by display device 100. In one example, a first illustration 601 may be drawn via first input device 200. Display device 100 may recognized first input device 200 via the first distortion associated with first input device 200 and associate first illustration 601 with first input device 200. Similarly, a second illustration 602 may be drawn via second input device 202. Display device 100 may recognized second input device 202 via the second distortion associated with second input device 202 and associate second illustration 602 with second input device 202.

In operation, different colors to may be automatically designated to each of first input device 200, second input device 202, and/or third input device 600. Alternatively, different colors to may be selected by a user to be associated with first input device 200, second input device 202, and/or third input device 600. In such an example, first illustration 601 may be of a first color while second illustration 602 may be of a second color. Additionally, each of first input device 200, second input device 202, and/or third input device 600 may have a visual indication (e.g., text, exterior coloring, the like, and/or combinations thereof) of what color will be associated by display device 100. Accordingly, different colors may be designated to each of first input device 200, second input device 202, and/or third input device 600.

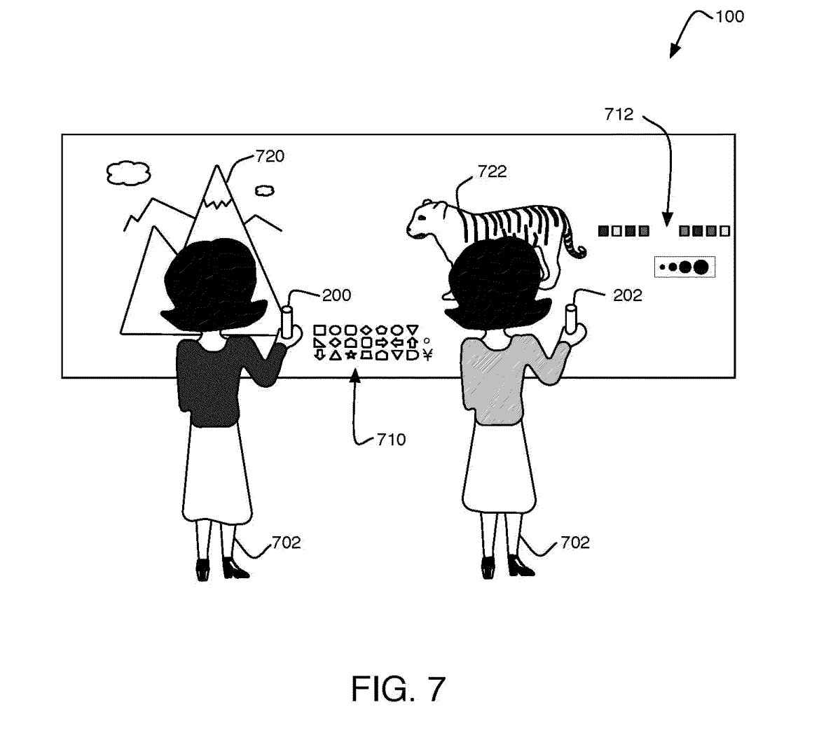

FIG. 7 illustrates another example diagram of input devices interacting with display device 100 that is arranged in accordance with at least some embodiments of the present disclosure. In the illustrated example, one or more users may interact with display device 100. For example, a first user 700 may interact with display device 100 via first input device 200. Similarly, a second user 702 may interact with display device 100 via second input device 202. First input device 200 and/or second input device 202 may be stylus-type input devices (see, e.g., FIG. 2), hand glove-type input devices (see, e.g., FIG. 4), finger cover-type input devices (see, e.g., FIG. 4), the like, and/or combinations thereof.

First input device 200 and second input device 202 may each have capacitive patterns that may be distinct from one another and may individually provide distortions to the electric field that may be differentiated by display device 100. For example, a first distortion associated with first input device 200 and a second distortion associated with second input device 202 may be differentiated by display device 100.

In one example, a first user interface 710 may be associated with first input device 200. Display device 100 may recognized first input device 200 via the first distortion associated with first input device 200 and associate first user interface 710 with first input device 200. Similarly, a second user interface 712 may be drawn via second input device 202. Display device 100 may recognized second input device 202 via the second distortion associated with second input device 202 and associate second user interface 712 with second input device 202.

In operation, different user interface may be automatically designated to each of first input device 200 and/or second input device 202. Alternatively, different user interface to may be selected by a user to be associated with first input device 200 and/or second input device 202. In such an example, a first illustration 720 may be made via first user interface 710 while second illustration 722 may be made via second user interface 712.

For example, two users (e.g., first and second uses 700 and 702) may draw pictures the same display device 100. First user 700 may be inserting a diagram and the second user 702 may be making a brush stroke. So, first user 700 may click a “rectangle” in a shape table associated with first user interface 710, and second user 702 may click “yellow” in a palette associated with second user interface 712. Then, first user 700 and second user 702 may draw on display device 100 with their respective first and second input devices 200 and 202. In this case, display device 100 may distinguish first input device 200 of first user 700 and second input device 202 of second user 702 via different capacitance patterns to perform the appropriate actions.

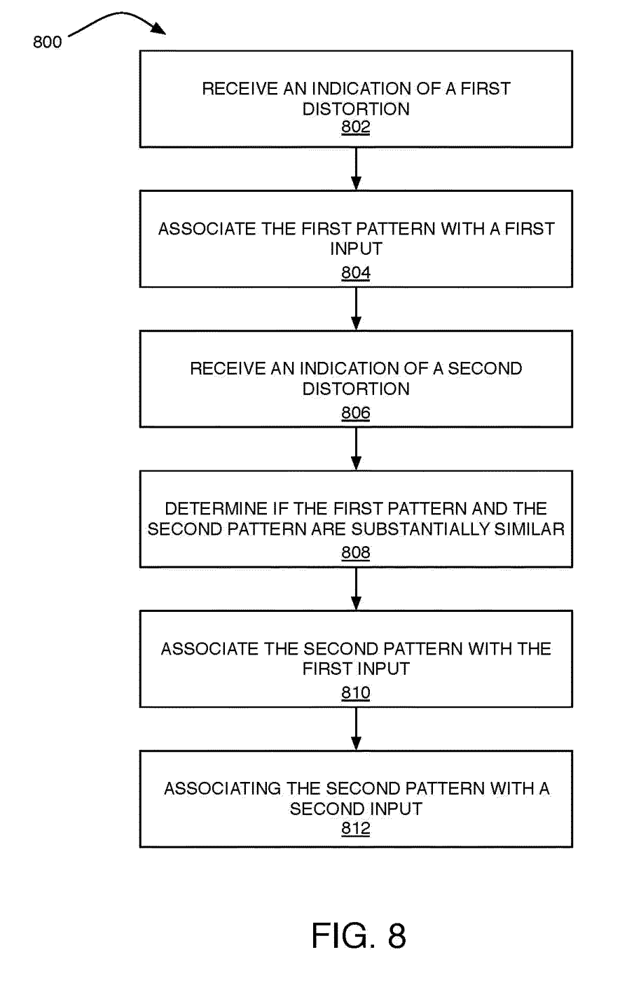

FIG. 8 illustrates an example process for differentiating inputs of a display device that is arranged in accordance with at least some embodiments of the present disclosure. A process 800, and other processes described herein, set forth various functional blocks or actions that may be described as processing steps, functional operations, events and/or acts, etc., which may be performed by hardware, software, and/or firmware. Those skilled in the art in light of the present disclosure will recognize that numerous alternatives to the functional blocks shown in FIG. 8 may be practiced in various implementations. For example, although process 800, as shown in FIG. 8, may comprise one particular order of blocks or actions, the order in which these blocks or actions are presented does not necessarily limit claimed subject matter to any particular order. Likewise, intervening actions not shown in FIG. 8 and/or additional actions not shown in FIG. 8 may be employed and/or some of the actions shown in FIG. 8 may be eliminated, without departing from the scope of claimed subject matter. Process 800 may include one or more of functional operations as indicated by example operations 802, 804, 806, 808, 810, and/or 812.

As illustrated, process 800 may be implemented for differentiating inputs of a display device (see FIG. 1). Processing may begin at operation 802, “RECEIVE AN INDICATION OF A FIRST DISTORTION”, where an indication of a first distortion may be received. For example, an indication of a first distortion of an electric field of the display device may be received. In such an example, the first distortion may have a first pattern. In some examples, the first distortion may include a first distortion caused by a conductive material.

Processing may continue from operation 802 to operation 804, “ASSOCIATE THE FIRST PATTERN WITH A FIRST INPUT”, where the first pattern may be associated with a first input. For example, the first pattern may be associated with a first. In another example, the first pattern may be associated with a first input of a first stylus type.

Processing may continue from operation 804 to operation 806, “RECEIVE AN INDICATION OF A SECOND DISTORTION”, where an indication of a second distortion may be received. For example, an indication of a second distortion of the electric field of the display device may be received. In such an example, the second distortion may have a second pattern. In some examples, the second distortion may include a second distortion caused by a conductive material.

Processing may continue from operation 806 to operation 808, “DETERMINE IF THE FIRST PATTERN AND THE SECOND PATTERN ARE SUBSTANTIALLY SIMILAR”, where a determination may be made if the first pattern and the second pattern are substantially similar.

Processing may continue from operation 808 to operation 810, “ASSOCIATE THE SECOND PATTERN WITH THE FIRST INPUT”, where the second pattern may be associated with the first input. For example, the second pattern may be associated with the first input if it is determined that the first pattern and the second pattern are substantially similar.

Alternatively, processing may continue from operation 808 to operation 812, “ASSOCIATING THE SECOND PATTERN WITH A SECOND INPUT”, where the second pattern may be associated with a second input. For example, the second pattern may be associated with a second input if it is determined that the first pattern and the second pattern are not substantially similar. In another example, the second pattern may be associated with a second input of a second stylus type if it is determined that the first pattern and the second pattern are not substantially similar.

In some examples, operation 808 may include classifying the first pattern and the second pattern among two or more predetermined patterns. In such examples, operation 804 of associating the first pattern with a first input may be based at least in part on one of the two or more predetermined patterns. Similarly, operation 812 of associating the second pattern with the second input may be based at least in part on one of the two or more predetermined patterns. In such examples, a dedicated action may be assigned to the first input and/or the second input based at least in part on the classification of the first pattern and the second pattern among the two or more predetermined patterns.

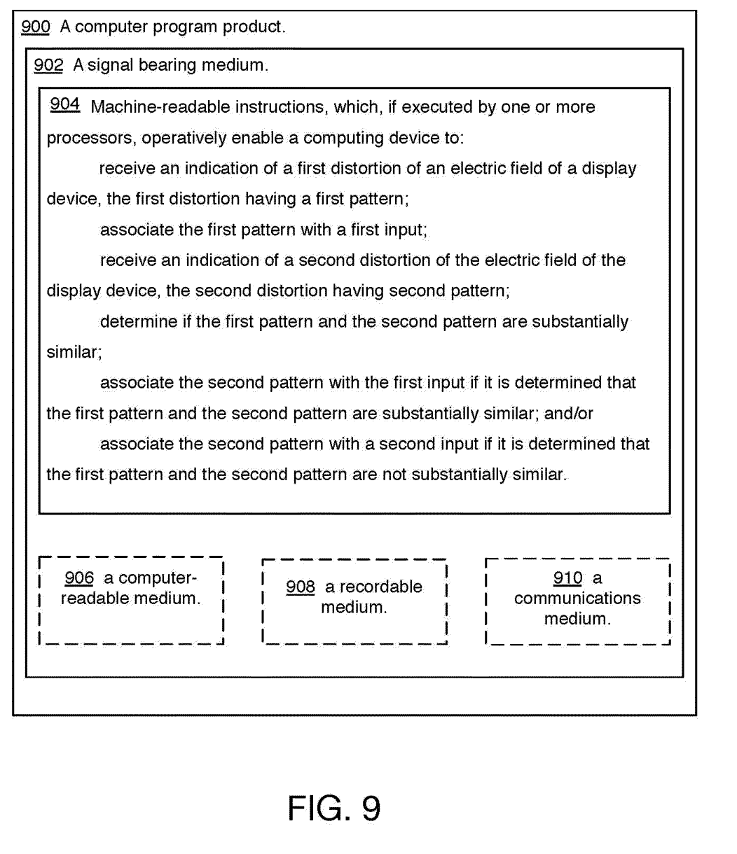

FIG. 9 illustrates an example computer program product 900 that is arranged in accordance with at least some examples of the present disclosure. Program product 900 may include a signal bearing medium 902. Signal bearing medium 902 may include one or more machine-readable instructions 904, which, if executed by one or more processors, may operatively enable a computing device to provide the functionality described above with respect to FIG. 8. Thus, for example, one or more display device 100 (see, e.g., FIG. 1) may undertake one or more of the actions shown in FIG. 8 in response to instructions 904 conveyed by medium 902.

In some implementations, signal bearing medium 902 may encompass a non-transitory computer-readable medium 906, such as, but not limited to, a hard disk drive, a Compact Disc (CD), a Digital Versatile Disk (DVD), a digital tape, memory, etc. In some implementations, signal bearing medium 902 may encompass a recordable medium 908, such as, but not limited to, memory, read/write (R/W) CDs, R/W DVDs, etc. In some implementations, signal bearing medium 902 may encompass communications medium 910, such as, but not limited to, a digital and/or an analog communication medium (e.g., a fiber optic cable, a waveguide, a wired communications link, a wireless communication link, etc.).

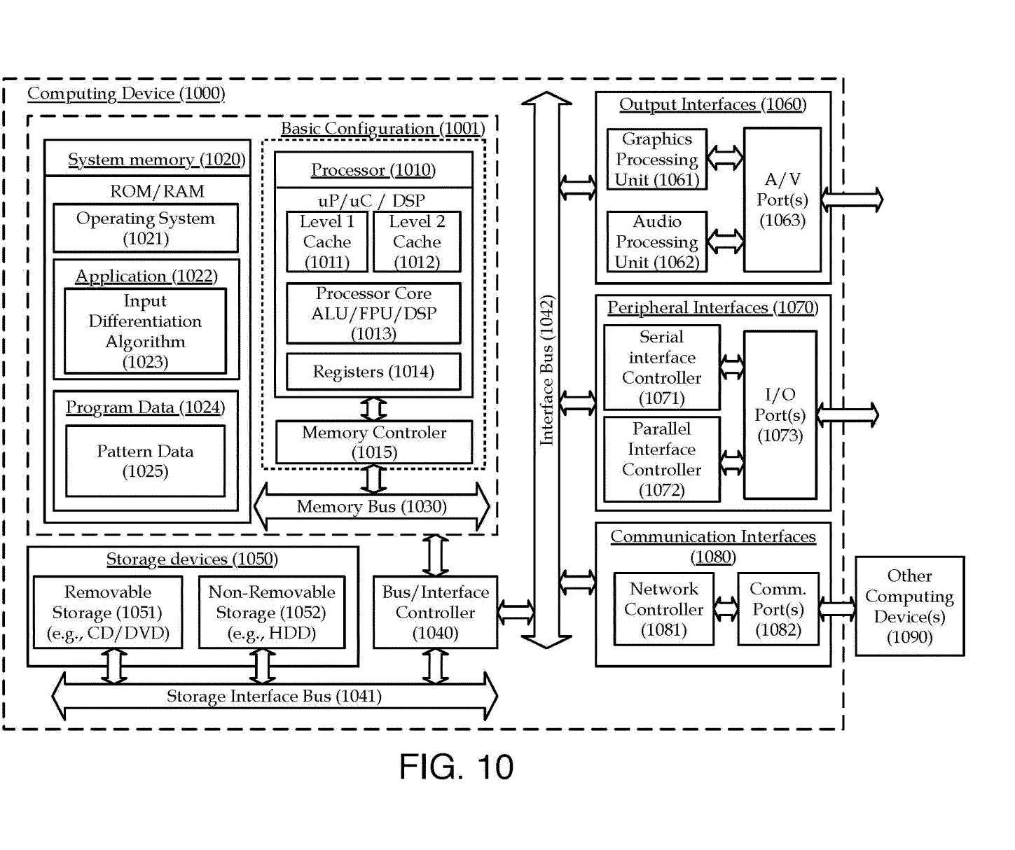

FIG. 10 is a block diagram illustrating an example computing device 1000, such as might be embodied by a person skilled in the art that is arranged in accordance with at least some embodiments of the present disclosure. In one example configuration 1001, computing device 1000 may include one or more processors 1010 and system memory 1020. A memory bus 1030 may be used for communicating between the processor 1010 and the system memory 1020.

Depending on the desired configuration, processor 1010 may be of any type including but not limited to a microprocessor (μP), a microcontroller (μC), a digital signal processor (DSP), or any combination thereof. Processor 1010 may include one or more levels of caching, such as a level one cache 1011 and a level two cache 1012, a processor core 1013, and registers 1014. The processor core 1013 may include an arithmetic logic unit (ALU), a floating point unit (FPU), a digital signal processing core (DSP Core), or any combination thereof. A memory controller 1015 may also be used with the processor 1010, or in some implementations the memory controller 1015 may be an internal part of the processor 1010.

Depending on the desired configuration, the system memory 1020 may be of any type including but not limited to volatile memory (such as RAM), non-volatile memory (such as ROM, flash memory, etc.) or any combination thereof. System memory 1020 may include an operating system 1021, one or more applications 1022, and program data 1024. Application 1022 may include an input differentiation algorithm 1023 that is arranged to perform the functions as described herein including the functional blocks and/or actions described with respect to process 800 of FIG. 8. Program Data 1024 may include mode and/or pattern data 1025 for use with input differentiation algorithm 1023. In some example embodiments, application 1022 may be arranged to operate with program data 1024 on an operating system 1021 such that implementations of input differentiation may be provided as described herein. For example, one or more display devices 100 (see, e.g., FIG. 1) may comprise all or a portion of computing device 1000 and be capable of performing all or a portion of application 1022 such that implementations of input differentiating may be provided as described herein. This described basic configuration is illustrated in FIG. 10 by those components within dashed line 1001.

Computing device 1000 may have additional features or functionality, and additional interfaces to facilitate communications between the basic configuration 1001 and any required devices and interfaces. For example, a bus/interface controller 1040 may be used to facilitate communications between the basic configuration 1001 and one or more data storage devices 1050 via a storage interface bus 1041. The data storage devices 1050 may be removable storage devices 1051, non-removable storage devices 1052, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1020, removable storage 1051 and non-removable storage 1052 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1000. Any such computer storage media may be part of device 1000.

Computing device 1000 may also include an interface bus 1042 for facilitating communication from various interface devices (e.g., output interfaces, peripheral interfaces, and communication interfaces) to the basic configuration 1001 via the bus/interface controller 1040. Example output interfaces 1060 may include a graphics processing unit 1061 and an audio processing unit 1062, which may be configured to communicate to various external devices such as a display or speakers via one or more A/V ports 1063. Example peripheral interfaces 1060 may include a serial interface controller 1071 or a parallel interface controller 1072, which may be configured to communicate with external devices such as input devices (e.g., keyboard, mouse, pen, voice input device, touch input device, etc.) or other peripheral devices (e.g., printer, scanner, etc.) via one or more I/O ports 1073. An example communication interface 1080 includes a network controller 1081, which may be arranged to facilitate communications with one or more other computing devices 1090 over a network communication via one or more communication ports 1082. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 1000 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 1000 may also be implemented as a personal computer including both laptop computer and non-laptop computer configurations. In addition, computing device 1000 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for differentiating inputs of a display device, the method comprising:
receiving an indication of a first distortion of an electric field of the display device, the first distortion having a first pattern;
associating the first pattern with a first input;
receiving an indication of a second distortion of the electric field of the display device, the second distortion having a second pattern;
determining if the first pattern and the second pattern are substantially similar;
associating the second pattern with the first input if it is determined that the first pattern and the second pattern are substantially similar; and
associating the second pattern with a second input if it is determined that the first pattern and the second pattern are not substantially similar.

2. The method of claim 1, wherein the display device comprises a touch screen type display device.

3. The method of claim 2, wherein the touch screen type display device comprises a capacitive touch technology type display device.

4. The method of claim 1, wherein the first and the second distortions comprise a first distortion and a second distortion caused by a conductive material.

5. The method of claim 4, wherein the conductive material comprises a stylus.

6. The method of claim 5, wherein the stylus comprises a stylus configured to provide one or more conductive patterns.

7. The method of claim 1, wherein the first input comprises an input associated with a first user.

8. The method of claim 1, wherein the second input comprises an input associated with a second user.

9. The method of claim 1, wherein the first input comprises an input associated with a first stylus type.

10. The method of claim 1, wherein the second input comprises an input associated with a second stylus type.

11. The method of claim 1, wherein determining if the first pattern and the second pattern are substantially similar further comprises classifying the first pattern and the second pattern among two or more predetermined patterns, wherein associating the first pattern with a first input is based at least in part on one of the two or more predetermined patterns, and wherein associating the second pattern with the second input is based at least in part on one of the two or more predetermined patterns.

12. The method of claim 11, further comprising assigning a dedicated action to the first input and/or the second input based at least in part on the classification of the first pattern and the second pattern among the two or more predetermined patterns.

13. An article comprising:
a signal bearing medium comprising machine-readable instructions stored thereon, which, if executed by one or more processors, operatively enable a computing device to:
receive an indication of a first distortion of an electric field of a display device, the first distortion having a first pattern;
associate the first pattern with a first input;
receive an indication of a second distortion of the electric field of the display device, the second distortion having second pattern;
determine if the first pattern and the second pattern are substantially similar;
associate the second pattern with the first input if it is determined that the first pattern and the second pattern are substantially similar; and
associate the second pattern with a second input if it is determined that the first pattern and the second pattern are not substantially similar.

14. The article of claim 13, wherein the display device comprises a touch screen type display device.

15. The article of claim 14, wherein the touch screen type display device comprises a capacitive touch technology type display device.

16. The article of claim 13, wherein the first and second distortions comprise a first distortion and a second distortion caused by a conductive material.

17. The article of claim 16, wherein the conductive material comprises a stylus.

18. The article of claim 17, wherein the stylus comprises a stylus configured to provide one or more conductive patterns.

19. An apparatus comprising:
a display device;
an input sensitive screen included in the display device;
conductive material included in the display device, the conductive material providing an electric field for the input sensitive screen;
a processor coupled to the display device; and
a signal bearing medium comprising machine-readable instructions stored thereon, which, if executed by the processor, operatively enable a computing device to:
receive an indication of a first distortion of the electric field of the display device, the first distortion having a first pattern;
associate the first pattern with a first input;
receive an indication of a second distortion of the electric field of the display device, the second distortion having second pattern;
determine if the first pattern and the second pattern are substantially similar;
associate the second pattern with the first input if it is determined that the first pattern and the second pattern are substantially similar; and
associate the second pattern with a second input if it is determined that the first pattern and the second pattern are not substantially similar.

20. The apparatus of claim 19, wherein the display device comprises a touch screen type display device.

21. The apparatus of claim 19, wherein the first and second distortions comprise a first distortion and a second distortion caused by a conductive material.

22. The apparatus of claim 21, wherein the conductive material comprises a stylus.

23. The apparatus of claim 22, wherein the stylus comprises a stylus configured to provide one or more conductive patterns.

24. The apparatus of claim 19, wherein the first input comprises an input associated with a first user.

25. The apparatus of claim 19, wherein the second input comprises an input associated with a second user.
